(19) United States
(12) Patent Application Publication
(10) Pub. No.: US 2008/0235586 A1
(43) Pub. Date: Sep. 25, 2008

(54) METHOD AND RELATED SYSTEM FOR MULTIPLE DISPLAYS

(76) Inventors: Hung-Te Chou, Taipei County (TW); Chun-Ming Su, Taipei County (TW); Hung-Te Lin, Taipei (TW); Yung-Chao Tseng, Taipei County (TW); Chih-Chung Chang, Taipei City (TW); Kuang-Che Wu, Taipei County (TW); Meng-Jyi Shieh, Taipei County (TW); Kuo-Hsin Yang, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/753,585

(22) Filed: May 25, 2007

(30) Foreign Application Priority Data
Mar. 19, 2007 (TW) 096109394

(51) Int. Cl. G06F 3/00

(52) U.S. Cl. 715/717

(57) ABSTRACT

The present invention disclosed a multiple display method. A media data is received and a first program corresponding to the media data is displayed on a first frame of a display device. The media data is analyzed to generate a second program according to a predetermined event. The second program is displayed on a second frame of the display device while displaying the first program on the first frame on a real time basis.

### BACKGROUND OF THE INVENTION

1. Field of the Invention

The present invention relates to a multiple display method and related display system, and more particularly, to a multiple display method and related display system capable of displaying media data on a real time basis and analyzed media data simultaneously.

2. Description of the Prior Art

As technology progresses, cable televisions can offer consumers more than a hundred channels. At the same time, display devices for television have developed with large-scaled design, such as large-scaled liquid crystal displays (LCD), plasma display panels (PDP), and organic light emitting diode (OLED) displays. Thus, display devices that can only display a single frame are unable to satisfy user's demands nowadays. Hence, display devices for supporting multiple display technology come with the tide of fashion.

Multiple display technology can provide a variety of operations to the users. For example, the user usually exchanges channels during a mass of selectable channels. That is, when watching a program A shown on a channel A, the user will change to a channel B to watch a program B while the program A proceeds through an advertisement segment and will change to the channel A again and again to make sure that the advertisement segment of the program A has terminated while watching the program B. In addition, the user may change channels again and again if there are two family members having different program opinions. At the same time, one control interface is necessary to input commands if the user want to alter any display settings of televisions. Hence, the television can display multiple channel frames simultaneously if it can support multiple display technology. If the size of the television is large enough, it can satisfy demands for multiple people/multiple channels at the same time and can show dialogue blocks or on-screen displays (OSD) related to display settings on monitors.

The abovementioned multiple display technology usually cooperates with a lot of selling neologisms to follow out. The multiple display technology can be divided into two major applications according to its technology nature: multiple outputs for identical frames and multiple outputs for different frames. Multiple outputs for identical frames are applied to occasions such as a briefing or a meeting, whereof the speakers connect a notebook having at least two video output ports to a large-scaled briefing projector. Hence, the meeting data can simultaneously be displayed on the notebook and on the monitor of the briefing projector. Similarly, if the video output port of a personal computer is connected to a television in the living room, the audio output port of the personal computer is connected to a hi-fi equipment in the living room, and a particular playing remote controller and suitable audio-video playing software are collocated, the personal computer can be viewed as an audio CD player, a VCD player, or a DVD player this moment. On the other hand, multiple outputs for different video frames can be applied to televisions. The video frames corresponding to different channels are simultaneously displayed on the same monitor by means of picture-in-picture or picture-on-picture to satisfy demands for multiple people/multiple channels at the same time.

### SUMMARY OF THE INVENTION

The present invention provides a multiple display method. The multiple display method includes receiving a media data and displaying a first program corresponding to the media data on a first frame, analyzing the media data to generate a second program, and displaying the second program on a second frame while displaying the first program on the first frame on a real time basis.

The present invention provides a multiple display method. The multiple display method includes receiving a first media data and displaying a first program corresponding to the first media data on a first frame, receiving and analyzing a second media data to which a second program corresponds to generate a third media data, and receiving the third media data and displaying a third program on a second frame while displaying the first program on a first frame on a real time basis.

The present invention provides a display system for multiple displays. The display system includes an analysis device and a display device. The analysis device is used for analyzing a media data to generate a corresponding first program. The display device is used for displaying a second program corresponding to the media data on a second frame while displaying the first program on a first frame on the real time basis. The display system further includes a receiving device for receiving the media data related to the first program and the second program.

The present invention provides a display system for multiple displays. The display system includes an analysis device, a first display device and a second display device. The analysis device is used for analyzing a media data to generate a corresponding first program. The first display device is used for displaying the first program on the real time basis. The second display device is used for displaying a second program. The display system further includes a receiving device for receiving the media data related to the first program and the second program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow diagram of a multiple display method of a first embodiment of the present invention.

FIG. 2 is a diagram of a display system for multiple displays of an embodiment of the present invention.

FIG. 3 is a flow diagram of a multiple display method of a second embodiment of the present invention.

FIG. 4 is a flow diagram of a multiple display method of a third embodiment of the present invention.

FIG. 5 is a flow diagram of a multiple display method of a fourth embodiment of the present invention.

FIG. 6 is a diagram of a display system for multiple displays of another embodiment of the present invention.

FIG. 7 is a flow diagram of a multiple display method of a fifth embodiment of the present invention.

FIG. 8 is a flow diagram of a multiple display method of a sixth embodiment of the present invention.

### DETAILED DESCRIPTION

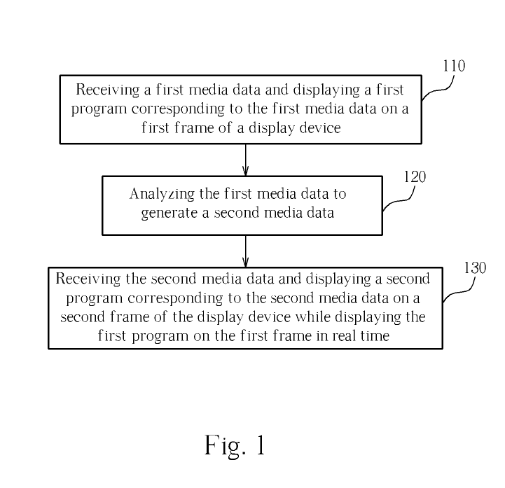

FIG. 1 is a flow diagram of a multiple display method of a first embodiment of the present invention. The diagram includes the following steps: receiving a first media data and displaying a first program corresponding to the first media data on a first frame of a display device (step 110); analyzing the first media data to generate a second media data (step 120); and receiving the second media data and displaying a second program corresponding to the second media data on a second frame of the display device while displaying the first program on the first frame in real time (step 130).

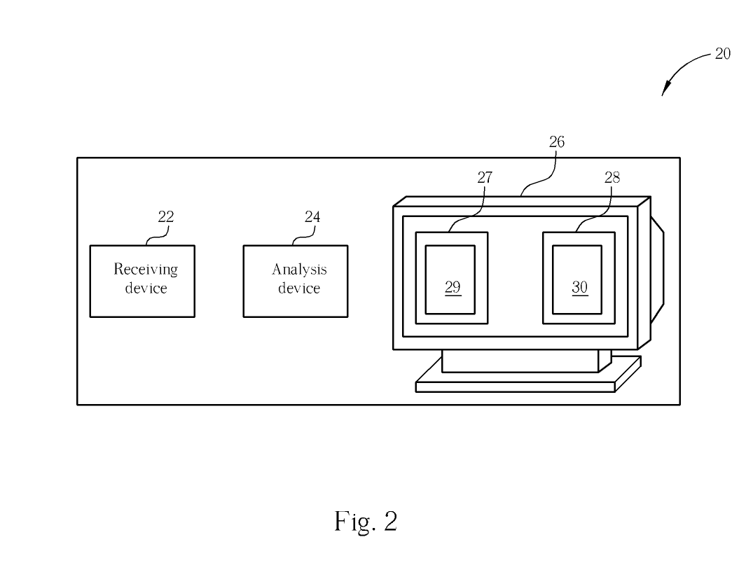

The multiple display method of the present invention can be utilized in a display system 20 for multiple displays comprising a receiving device 22, an analysis device 24 and a display device 26. As shown in FIG. 2, the receiving device 22 is used for receiving a media data, which is related to a first program 29 and/or a second program 30. The analysis device 24 is used for analyzing the media data according to a predetermined manner. In detail, the media data is analyzed to generate another media data related to a second program 30 according to a predetermined manner. The display device 26 is used for simultaneously displaying the second program 30 on a second frame 28 while displaying the first program 29 on a first frame 27 on the real time basis.

Moreover, the display system can receive and analyze contents of a media data from a cable service provider or other source, and can display the analyzed media data on different frames of a display device in real time. Note that as used herein the term “media data” refers to an image/video data, audio data or synchronized image/video and audio data. The media data may include live or recorded formats such as films or broadcast live audio or video feed.

In the first embodiment of the present invention, the first media data related to the first program is received in step 110, and the first media data is analyzed according to a predetermined manner in step 120. The predetermined manner will be described thereinafter. Hence, the first program can be displayed on the first frame of the display device and the second program can be displayed on the second frame of the same display device, simultaneously.

In the first embodiment of the present invention, the second frame can be a single picture-in-picture (PIP), a dual picture-in-picture, a twin view picture-on-picture, a picture-on-picture (POP) or split-screen picture, a picture-by-picture (PBP) or an on-screen display (OSD) of the first frame.

Please note that, the predetermined manner used for analyzing the first media data can be decided according to program types, channels, events, sound/voice, or user's favors or preference, which is predetermined, and the second program is generated according to contents related to the predetermined event of the media data. In the following examples are used for illustrating applications for the first embodiment of the present invention.

Please refer to the Table 1 listed in the following, the first program, for example, can be a baseball game, a soccer game, or a sumo game. And the predetermined manner used for analyzing the first media data, take the baseball game for example, can be pitches, a strike, walks, a home run, or points scored. Therefore, the first media data can be analyzed according to different parameters (different predetermined manners).

TABLE 1

| Baseball Game | Soccer Game | Sumo Game |
|---|---|---|
| Pitches | Goals and near goals | Fight begins |
| Strikes and | Issuing of red and yellow | Competitors' names on |
| walks | cards | screen |
| Home runs | Rule violations, such as | |
| | fights | |
| Points scored | Accidents and injuries | |

In a first application, the first program, for example, is a live broadcast baseball game. In step 120, a predetermined event (such as a home run, strikes, walks, points scored, player information, or other highlights) of the first program can be found by analyzing the first media data, and contents related to the predetermined event of the first media data is integrated into the second media data. And then the second program generated from the second media data is displayed on the second frame in step 130. In this application, the second program can be viewed as splendid segments or highlights of the baseball game. The user can simultaneously watch the splendid segments of the baseball game on the second frame while watching the live broadcast baseball game on the first frame of a display device.

In a second application, the first program, for example, is an awards ceremony. In step 120, the predetermined event of the first program (such as issuing particular awards) can be found by analyzing the first media data, and contents related to the predetermined event of the first media data is integrated into the second media data. And then the second program generated from the second media data is displayed on the second frame in step 130. In this application, the second program can be viewed as key-point reviews of the awards ceremony. The user can simultaneously watch the key-point reviews of the awards ceremony on the second frame while watching the awards ceremony on the first frame.

In a third application, the first program is, for example, a television video album. In step 120, advertisement segments of the first program can be found by analyzing the first media data, and contents related to the advertisement segments of the first media data is integrated into the second media data. And then the second program generated from the second media data is displayed on the second frame in step 130. Therefore, the user can simultaneously watch the advertisement segments on the second frame while watching the television video album on the first frame of a display device.

In a fourth application, contents of the previously broadcasted first media data can be integrated into the second media data in step 120, and then the second program generated from the second media data is displayed on the second frame in step 130. In this application, the second program can be viewed as rebroadcast or replay contents of the first program. Therefore, the user can simultaneously watch the rebroadcast/replay contents of the second program on the second frame while watching the first program on the first frame.

The above applications are provided as some specific examples of how to practice the first embodiment of the invention, and thus, the scope of the invention does not limit to the above examples.

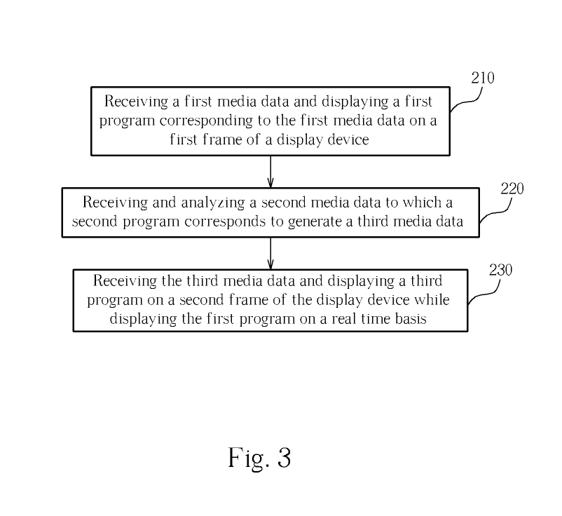

The present invention is further capable of being directed against two different media data, in which a media data and another analyzed media data are respectively displayed on two different frames of a display device on a real time basis. FIG. 3 is a flow diagram of a multiple display method of a second embodiment of the present invention. The flow diagram includes the following steps: receiving a first media data and displaying a first program corresponding to the first media data on a first frame of a display device (step 210); receiving and analyzing a second media data to which a second program corresponds to generate a third media data (step 220); and receiving the third media data and displaying a third program on a second frame of the display device while displaying the first program on a real time basis (step 230).

The second embodiment of the present invention is similar to the first embodiment of the present invention, the difference between them is that the first embodiment analyzed the first media data to generate the second media data in step 120, but the second embodiment analyzed the second media data to generate the third media data in step 220. Namely, the contents shown in the first frame and shown in the second frame in the first embodiment are related to the same program, but the contents shown in the first frame and those shown in the second frame in the second embodiment are related to different programs. Therefore, the user can simultaneously watch the contents of the second program after analyzing in step 220 on the second frame while watching the first program on the first frame.

In the second embodiment of the present invention, the second frame can be a picture-in-picture (PIP), a picture-on-picture (POP), a picture-by-picture (PBP) or an on-screen display (OSD) of the first frame.

Please note that, the predetermined manner used for analyzing the second media data can be decided according to program types, channels, events, sound/voice, or user's favors or preference, which is predetermined, and the third program is generated according to contents related to the predetermined event of the second media data.

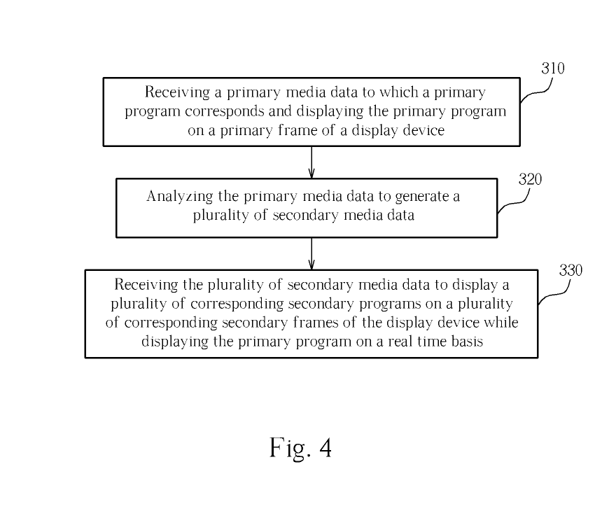

The present invention is further capable of being directed against a plurality of media data, in which a media data and many other analyzed media data are individually displayed on different frames of a display device on a real time basis. FIG. 4 is a flow diagram of a multiple display method of a third embodiment of the present invention. The flow diagram includes the following steps: receiving a primary media data to which a primary program corresponds and displaying the primary program on a primary frame of a display device (step 310); analyzing the primary media data to generate a plurality of secondary media data (step 320); and receiving the plurality of secondary media data to display a plurality of corresponding secondary programs on a plurality of corresponding secondary frames of the display device while displaying the primary program on a real time basis (step 330).

The third embodiment of the present invention is similar to the first embodiment of the present invention, the difference between them is that the first embodiment analyzed the first media data to generate the second media data in step 120, but the third embodiment analyzes the primary media data and generates the plurality of corresponding secondary media data in step 320. That is, the first embodiment simultaneously displays the second program on another frame while displaying the first program on the first frame, but the third embodiment simultaneously displays the plurality of secondary programs on the plurality of other frames, respectively, while displaying the primary program on the primary frame. Therefore, the user can simultaneously watch the contents of the plurality of secondary programs after analyzing in step 320 on the plurality of secondary frames while watching the primary program on the primary frame.

Please note that, in the first embodiment, the first program and the second program are respectively displayed on the first frame and the second frame of the display device. For example, a live broadcast baseball game is displayed on the first frame while a home run is displayed on a second frame. Therefore, the first frame and the second frame are just like a picture-by-picture. In the third embodiment, the primary program and the plurality of secondary programs are respectively displayed on the primary frame and the plurality of secondary frame of the display device. For example, a live broadcast baseball game is displayed on the primary frame while a home run is displayed on a first secondary frame, a strike is displayed on a second secondary frame, and point scored is displayed on a third secondary frame. Therefore, the primary frame and the plurality of secondary frames are just like a picture-in-picture.

In the third embodiment of the present invention, the secondary frame can be a picture-in-picture (PIP), a picture-on-picture (POP), a picture-by-picture (PBP) or an on-screen display (OSD) of the primary frame.

Please note that, the predetermined manner used for analyzing the primary media data can be determined according to program types, channels, events, sound/voice, or user's favors or preference, which is predetermined, and the secondary program is generated according to contents related to the predetermined event of the primary media data. The following examples are used for illustrating applications for the third embodiment of the present invention.

In a fifth application, the primary program is, for example, a live broadcast baseball game. In step 320, different predetermined events (such as a home run, strikes, walks, or points scored) of the primary program can be found by analyzing the primary media data, and contents related to different predetermined events of the primary media data are individually generated or integrated into a plurality of secondary media data. And then the plurality of corresponding secondary programs are individually displayed on the plurality of secondary frames in step 330. In this application, the plurality of secondary programs can be viewed as different highlights or splendid segments of the baseball game. The user can simultaneously watch the plurality of different splendid segments of the primary program on the plurality of secondary frames while watching the live broadcast baseball game on the primary frame. For example, a home run is displayed on a first secondary frame, a strike is displayed on a second secondary frame, and point scored is displayed on a third secondary frame.

In a sixth application, the primary program is, for example, an awards ceremony. In step 320, the predetermined events of the primary program (such as issuing different awards) can be found by analyzing the primary media data, and contents related to different predetermined events of the primary media data are individually generated and integrated into the plurality of secondary media data. Then a plurality of corresponding secondary programs are individually displayed on the plurality of secondary frames in step 330. In this application, the plurality of corresponding secondary programs can be viewed as different key-point reviews of the awards ceremony. The user can simultaneously watch the different key-point reviews of the awards ceremony on the plurality of secondary frames while watching the awards ceremony on the primary frame. For example, issuing a best director award is displayed on a first secondary frame, issuing a best chief actor award is displayed on a second secondary frame, and issuing a best chief actress award is displayed on a third secondary frame. Please note that, the analyzing step can be done by detecting predetermined keywords or sound such as best, chief, actor, actress, director, and other keywords of the primary media data to generate the plurality of secondary media data. The invention does not limit how to generate the secondary media data.

In a seventh application, the primary program is, for example, a television video album. In step 320, different advertisement segments of the primary program can be found and contents related to the different advertisement segments of the primary media data are individually integrated into the plurality of secondary media data. And then the plurality of corresponding secondary programs are individually displayed on the plurality of secondary frames in step 330. Note, each secondary program is related to a certain characteristic selected or grouped from contents contained in the primary media data. Therefore, the user can simultaneously watch the different advertisement segments on the plurality of secondary frames while watching the television video album on the primary frame. For example, all car advertisements are grouped and displayed on a first secondary frame, all food advertisements are grouped and displayed on a second secondary frame, and other advertisements are displayed on a third secondary frame.

In an eighth application, contents of the primary media data previously broadcasted at different time points can be individually integrated into the plurality of secondary media data in step 320, and then the plurality of corresponding secondary programs are individually displayed on the plurality of secondary frames in step 330. In this application, the plurality of corresponding secondary programs can be viewed as rebroadcast or replay contents of the primary program at different time points. Therefore, the user can simultaneously watch the rebroadcast or replay contents of the primary program at different time points on the plurality of secondary frames while watching the primary program on the primary frame. For example, the contents broadcasted ten minutes ago are displayed on a first secondary frame, the contents broadcasted one half hour ago are displayed on a second secondary frame, and the contents broadcasted one hour ago are displayed on a third secondary frame. The replay time of each secondary program can be set by users or predetermined.

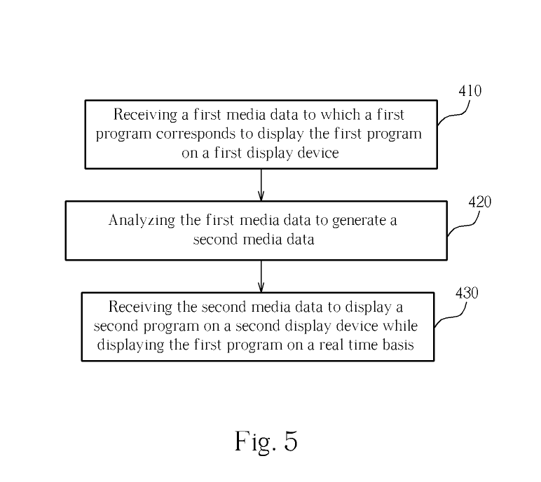

The present invention is further capable of analyzing contents of a media data and individually displaying the media data and analyzed media data on different frames on different display devices on a real time basis. FIG. 5 is a flow diagram of a multiple display method of a fourth embodiment of the present invention. The flow diagram includes the following steps: receiving a first media data to which a first program corresponds to display the first program on a first display device (step 410); analyzing the first media data to generate a second media data (step 420); receiving the second media data to display a second program on a second display device while displaying the first program on a real time basis (step 430).

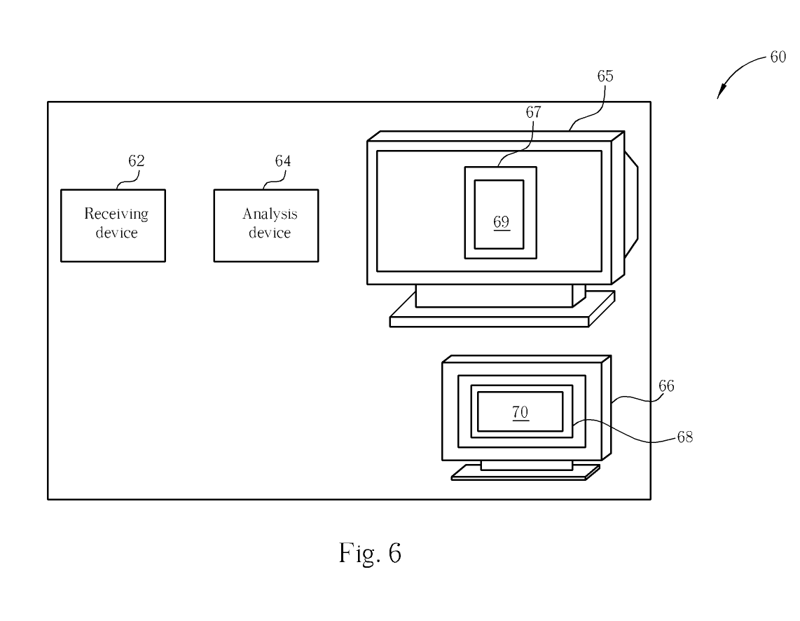

The following embodiments are related to another display system comprising at least two display devices. In this embodiment, a display system 60 for multiple displays comprises a receiving device 62, an analysis device 64, a first display device 65, and a second display device 66. As shown in FIG. 6, the receiving device 62 is used for receiving media data related to the first program 69 and/or the second program 70. The analysis device 64 is used for analyzing a media data. The first display device 65 is used for displaying the first program 69 on a first frame 67 on the real time basis. The second display device 66 is used for displaying a second program 70 on a second frame 68.

The fourth embodiment of the present invention is similar to the first embodiment of the present invention, the difference between them is that the first embodiment displays the second program on the second frame of the display device in step 130, but the fourth embodiment displays the second program on the second display device in step 430. Namely, the first embodiment of the present invention displays the first program and the second program on the same display device but the fourth embodiment of the present invention displays the first program and the second program on different frames on different display devices. Therefore, the user can simultaneously watch the second program on the second display device while watching the first program on the first display device on a real time basis. In the fourth embodiment of the present invention, the first and the second display devices can be display devices of identical types (for example, both are televisions) or of different types (for example, a television and a computer monitor), and the predetermined manner used for analyzing the first media data can be decided according to program types, channels, events, sound/voice, or user's favors or preference, which is predetermined, and the second program is generated according to contents related to the predetermined event of the first media data.

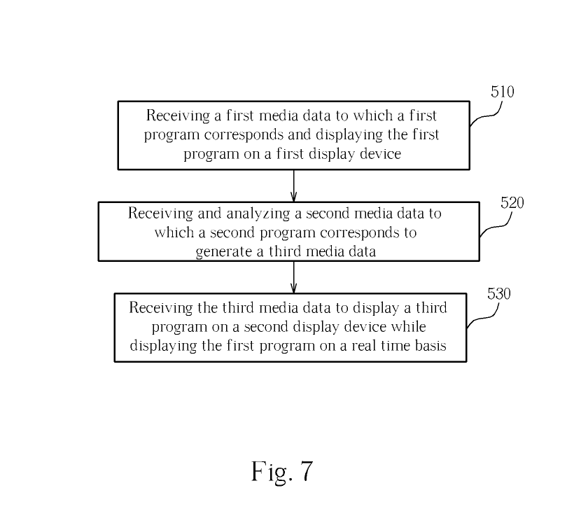

The present invention is further capable of being directed against two media data, in which a media data and another analyzed media data are individually displayed on two different display devices on a real time basis. FIG. 7 is a flow diagram of a multiple display method of a fifth embodiment of the present invention. The flow diagram includes the following steps: receiving a first media data to which a first program corresponds and displaying the first program on a first display device (step 510); receiving and analyzing a second media data to which a second program corresponds to generate a third media data (step 520); receiving the third media data to display a third program on a second display device while displaying the first program on a real time basis (step 530).

The fifth embodiment of the present invention is similar to the second embodiment of the present invention, the difference between them is that the second embodiment individually displays the first program on the first frame and displays the third program on the second frame of a display device, but the fifth embodiment displays the first program and the third program on the first display device and on the second display device, respectively. That is, the second embodiment of the present invention displays the first program and the third program on the same display device, but the fifth embodiment of the present invention displays the first program and the third program on different display devices. Therefore, the user can simultaneously watch the third program on the second display device while watching the first program on the first display device on a real time basis. In the fifth embodiment of the present invention, the first and the second display devices can be display devices of identical types (for example, both are televisions) or of different types (for example, a television and a computer monitor), and the predetermined manner used for analyzing the second media data can be decided according to program types, channels, events, sound/voice, or user's favors or preference, which is predetermined, and the third media data is generated according to contents related to the predetermined event of the second media data.

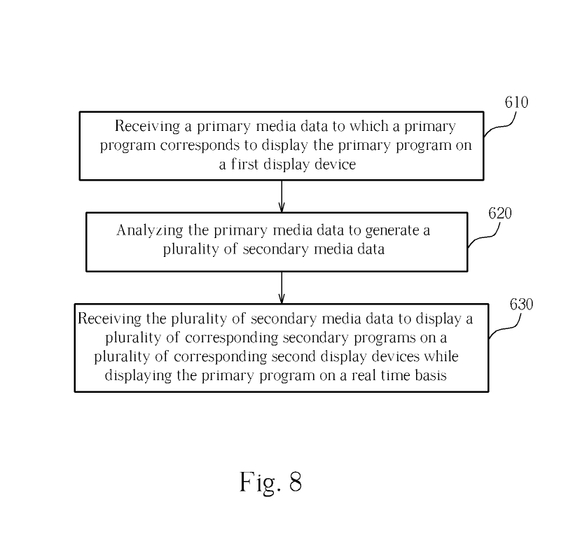

The present invention is further capable of being directed against many media data, whereof a media data and many other analyzed media data are individually displayed on different display devices on a real time basis. Please refer to FIG. 8. FIG. 8 is a flow diagram of a multiple display method according to a sixth embodiment of the present invention. The flow diagram includes the following steps: receiving a primary media data to which a primary program corresponds to display the primary program on a first display device (step 610); analyzing the primary media data to generate a plurality of secondary media data (step 620); receiving the plurality of secondary media data to display a plurality of corresponding secondary programs on a plurality of corresponding second display devices while displaying the primary program on a real time basis (step 630).

The sixth embodiment of the present invention is similar to the third embodiment of the present invention, the difference between them is that the third embodiment individually displays the primary program and the plurality of secondary programs on the primary frame and the plurality of secondary frames of a display device, but the sixth embodiment displays the primary program and the plurality of secondary programs on the first display device and the plurality of second display devices, respectively. Namely, the third embodiment of the present invention displays the primary program and the plurality of secondary programs on the same display device but the sixth embodiment of the present invention displays the primary program and the plurality of secondary programs on different display devices. Therefore, the user can simultaneously watch the plurality of secondary programs on the plurality of corresponding second display devices while watching the primary program on the first display device on a real time basis. In the sixth embodiment of the present invention, the first and the plurality of second display devices can be display devices of identical types (for example, all are televisions) or of different types (for example, a television and a plurality of computer monitors, or vice versa). The predetermined manner used for analyzing the primary media data can be decided according to program types, channels, events, sound/voice, or user's favors or preference, which is predetermined, and the plurality of secondary media data is generated according to contents related to the predetermined event of the primary media data.

Those skilled in the art will readily observe that numerous modifications and alterations of the device and method may be made while retaining the teachings of the invention.

What is claimed is:

1. A multiple display method comprising:
receiving a media data and displaying a first program corresponding to the media data on a first frame;
analyzing the media data to generate a second program; and
displaying the second program on a second frame while displaying the first program on the first frame on a real time basis.

2. The multiple display method of claim 1 further comprising displaying the first frame and the second frame on the same display device.

3. The multiple display method of claim 1 further comprising displaying the first frame on a first display device, and displaying the second frame on a second display device.

4. The multiple display method of claim 1, wherein the step of receiving the media data further comprises:
receiving a first media data related to the first program and a second media data related to the second program.

5. The multiple display method of claim 1, wherein the step of analyzing the media data to generate the second program further comprises:
analyzing the media data according to a predetermined event; and
generating the second program according to contents related to the predetermined event of the media data.

6. The multiple display method of claim 5, wherein the predetermined event comprises program types, channels, events, sound/voice, or user's favors or preference.

7. The multiple display method of claim 1, wherein the second frame is a picture-in-picture (PIP), a picture-on-picture (POP), an on-screen display (OSD) or a picture-by-picture (PBP) of the first frame.

8. The multiple display method of claim 1, wherein the step of analyzing the media data to generate the second program comprises analyzing the media data to generate a plurality of different or identical second programs.

9. The multiple display method of claim 8, wherein the step of displaying the second program on the second frame comprises displaying the plurality of second programs on a plurality of corresponding second frames.

10. The multiple display method of claim 9 further comprising displaying the first frame and the plurality of second frames on the same display device.

11. The multiple display method of claim 9 further comprising displaying the first frame on a first display device, and displaying the plurality of second frames on a plurality of second display devices.

12. The multiple display method of claim 8, wherein the step of analyzing the media data to generate the second program further comprises:
analyzing the media data according to a plurality of different predetermined events; and
generating the plurality of second programs according to contents related to the plurality of different predetermined events of the media data.

13. The multiple display method of claim 12, wherein the plurality of predetermined events comprise program types, channels, events, sound/voice, or user's favors or preference.

14. The multiple display method of claim 9, wherein the plurality of second frames are a plurality of picture-in-picture (PIP), a plurality of picture-on-picture (POP), a plurality of on-screen display (OSD) or a plurality of picture-by-picture (PBP) of the first frame.

15. The multiple display method of claim 1, wherein the step of analyzing the media data to generate the second program comprises analyzing a plurality of media data to generate a plurality of second programs.

16. The multiple display method of claim 15, wherein the step of displaying the second program on the second frame comprises individually displaying the plurality of second programs on a plurality of corresponding second frames.

17. The multiple display method of claim 15 further comprising displaying the first frame and the plurality of second frames on the same display device.

18. The multiple display method of claim 15 further comprising displaying the first frame on a first display device, and individually displaying the plurality of second frames on a plurality of second display devices.

19. The multiple display method of claim 15, wherein the step of analyzing the media data to generate the second program further comprises:
analyzing the plurality of media data according to a plurality of different predetermined events; and
generating the plurality of second programs according to contents related to the plurality of different predetermined events of the plurality of media data.

20. The multiple display method of claim 19, wherein the plurality of predetermined events comprise program types, channels, events, sound/voice, or user's favors or preference.

21. The multiple display method of claim 16, wherein the plurality of second frames are a plurality of picture-in-picture (PIP), a plurality of picture-on-picture (POP), a plurality of on-screen display (OSD) or a plurality of picture-by-picture (PBP) of the first frame.

22. The multiple display method of claim 1, wherein:
the first program comprises a primary program related to the media data; and
the second program comprises a secondary program related to the analyzed media data.

23. The multiple display method of claim 1, wherein:
the first program is related to a first media data; and
the second program is related to a second media data.

24. A multiple display method comprising:
receiving a first media data and displaying a first program corresponding to the first media data on a first frame;
receiving and analyzing a second media data to which a second program corresponds to generate a third media data; and
receiving the third media data and displaying a third program on a second frame while displaying the first program on a first frame on a real time basis.

25. The multiple display method of claim 24 further comprising displaying the first frame and the second frame on the same display device.

26. The multiple display method of claim 24 further comprising displaying the first frame on a first display device, and displaying the second frame on a second display device.

27. The multiple display method of claim 24, wherein the step of analyzing the second media data to which the second program corresponds to generate the third media data further comprises:
analyzing the second media data according to a predetermined event; and
generating the third media data according to contents related to the predetermined event of the media data.

28. The multiple display method of claim 27, wherein the predetermined event comprises program types, channels, events, sound/voice, or user's favors or preference.

29. The multiple display method of claim 24, wherein the second frame is a picture-in-picture (PIP), a picture-on-picture (POP), an on-screen display (OSD) or a picture-by-picture (PBP) of the first frame.

30. The multiple display method of claim 24, wherein the step of analyzing the second media data to generate the third media data comprises analyzing the second media data to generate a plurality of different or identical third media data.

31. The multiple display method of claim 30, wherein the step of displaying the third program on the second frame comprises displaying the plurality of third programs on a plurality of corresponding second frames.

32. The multiple display method of claim 31 further comprising displaying the first frame and the plurality of second frames on the same display device.

33. The multiple display method of claim 31 further comprising displaying the first frame on a first display device, and displaying the plurality of second frames on a plurality of second display devices.

34. The multiple display method of claim 30, wherein the step of analyzing the second media data to generate the third media data further comprises:
analyzing the second media data according to a plurality of different predetermined events; and
generating the plurality of third media data according to contents related to the plurality of different predetermined events of the second media data.

35. The multiple display method of claim 34, wherein the plurality of different predetermined events comprise program types, channels, events, sound/voice, or user's favors or preference.

36. The multiple display method of claim 31, wherein the plurality of second frames are a plurality of picture-in-picture (PIP), a plurality of picture-on-picture (POP), a plurality of on-screen display (OSD) or a plurality of picture-by-picture (PBP) of the first frame.

37. The multiple display method of claim 24, wherein the step of analyzing the second media data to generate the third media data comprises analyzing a plurality of second media data to generate a plurality of third media data.

38. The multiple display method of claim 37, wherein the step of displaying the third program on the second frame comprises individually displaying the plurality of third programs on a plurality of corresponding second frames.

39. The multiple display method of claim 37 further comprising displaying the first frame and the plurality of second frames on the same display device.

40. The multiple display method of claim 37 further comprising displaying the first frame on a first display device, and individually displaying the plurality of second frames on a plurality of second display devices.

41. The multiple display method of claim 37, wherein the step of analyzing the second media data to generate the third media data further comprises:
analyzing the plurality of second media data according to a plurality of different predetermined events; and
generating the plurality of third media data according to contents related to the plurality of different predetermined events of the plurality of second media data.

42. The multiple display method of claim 37, wherein the plurality of different predetermined events comprise program types, channels, events, sound/voice, or user's favors or preference.

43. The multiple display method of claim 37, wherein the plurality of second frames are a plurality of picture-in-picture (PIP), a plurality of picture-on-picture (POP), a plurality of on-screen display (OSD) or a plurality of picture-by-picture (PBP) of the first frame.

44. A display system for multiple displays, the display system comprising:
an analysis device used for analyzing a media data; and
a display device used for displaying a second program corresponding to the media data on a second frame while displaying the first program on a first frame on the real time basis.

45. The display system of claim 44 further comprising:
a receiving device used for receiving the media data related to the first program and the second program.

46. A display system for multiple displays, the display system comprising:
an analysis device used for analyzing a media data;
a first display device used for displaying the first program on the real time basis; and
a second display device used for displaying a second program.

47. The display system of claim 46 further comprising:
a receiving device used for receiving the media data related to the first program and the second program.
